(19) United States
(12) Patent Application Publication
(10) Pub. No.: US 2014/0175165 A1
(43) Pub. Date: Jun. 26, 2014

(54) BAR CODE SCANNER WITH INTEGRATED SURFACE AUTHENTICATION

(71) Applicant: HONEYWELL SCANNING AND MOBILITY, Fort Mill, SC (US)

(72) Inventors: William H. Havens, Syracuse, NY (US); Donald Anderson, Locke, NY (US)

(73) Assignee: Honeywell Scanning and Mobility, Fort Mill, SC (US)

(21) Appl. No.: 13/865,607

(22) Filed: Apr. 18, 2013

Related U.S. Application Data
(60) Provisional application No. 61/740,964, filed on Dec. 21, 2012.

(51) Int. Cl. G06K 5/00

(52) U.S. Cl. CPC G06K 5/00
USPC 235/375

(57) ABSTRACT

In general, techniques are described for performing surface authentication with a scanning device to authenticate items. The scanning device or “scanner” that includes a bar code reader, a surface reader and a controller may implement the techniques. The bar code reader is configured to read a bar code affixed to an item to determine bar code data. The surface reader is configured to read a surface of the item to determine a representation of the surface. The controller is configured to determine whether the item is authentic based on the bar code data and the representation of the surface and provides an indication that the item has been authenticated based on the determination of whether the item is authentic. In this way, a scanner may perform item authentication based on both the bar code data and the representation of the surface of the item.

This application claims the benefit of U.S. Provisional Application No. 61/740,964, filed Dec. 21, 2012, the entire content of each of which being incorporated herein by reference.

### TECHNICAL FIELD

This disclosure relates to a bar code scanner and, more specifically, a bar code scanner that performs surface authentication.

### BACKGROUND

Bar code scanners are used in many applications and may include scanning electronics for bar code decoding and other techniques. A bar code scanner can acquire data quickly and enables verification of the items to which bar codes are affixed. For example, a bar code scanner may provide verification that a medicine is authorized for use with a particular patient. A doctor, nurse, or other hospital personnel may affix a bar code to a patient, often in the form of a wrist band. A nurse administering a medicine to a patient may scan the patient's bar code and then scan the medicine's bar code. The bar code scanner may then interface with a server (and possibly an off-site network) to confirm that the medicine may be administered to the patient.

While bar code scanners may facilitate the capture or acquisition of data in a number of contexts, including the medical context noted above, bar code scanners may not eliminate certain security risks. For example, a medicinal package may contain counterfeit medicine from an unknown supplier. The unknown supplier may have produced a counterfeit medicinal package which replicates the bar code on a legitimate medicinal package. The bar code from the legitimate medicinal package may be well known and may be relatively easy to reproduce. Thus, a valid bar code on a medicinal package may not guarantee that the medicine inside the package is authentic. This can compromise patient safety if the patient receives a counterfeit medicine which is ineffective or even harmful to that patient.

### SUMMARY

In general, techniques are described for providing a way by which to verify the integrity of products associated with bar codes or other machine-readable indicia. Rather than rely solely on a bar code to authenticate an item, the techniques may involve augmenting bar code scanning with a surface authentication process. Surface authentication generally involves scanning a surface of an item, such as a medicine package, to produce a digital serial code that effectively represents the scanned surface of this item. In some cases it may also be possible to scan the surface of the medication itself. This surface scan may be at a resolution that enables two similar items (e.g., similar medicine containers that contain different medicines or medicines at different does) to be distinguished from one another. A bar code scanner may perform the techniques described in this disclosure to both read a bar code to obtain bar code data and perform a surface scan to determine a representation of the surface (e.g., in the form of the above noted digital serial code). The bar code scanner may then authenticate the item based on both the bar code data and the representation of the surface. By authenticating the item based on the representation of the surface of the item, the techniques may promote efficient authentication of the item in a way that possibly cannot be forged or counterfeited.

### BRIEF DESCRIPTION OF DRAWINGS

FIG. 1 is a diagram illustrating a system incorporating a bar code scanner network that operates in accordance with the techniques described in this disclosure.

FIG. 2A is a block electrical diagram showing a bar code scanner that includes a surface authentication scanner and a bar code scanner.

FIG. 2B is a block electrical diagram showing a bar code scanner base.

FIG. 3 is a perspective view illustrating a bar code scanner that operates in accordance with various aspects of the techniques described in this disclosure.

FIG. 4A is a block diagram illustrating components of a surface authentication reader module that can be used in conjunction with a bar code reader to perform various aspects of the techniques described in this disclosure.

FIG. 4B is a block diagram illustrating a bar code reader module that can be used in conjunction with a surface authentication reader in accordance with various aspects of the techniques described in this disclosure.

FIG. 5A and FIG. 5B are diagrams illustrating the distances of separation between a surface authentication scan area and a bar code scan area in a horizontal and vertical orientation, respectively, on the surface of the item being scanned in accordance with aspects of the techniques described in this disclosure.

FIG. 6 is a flowchart illustrating steps of a process that can be performed in accordance with the aspects of this disclosure by a bar code scanner operating within a bar code scanner network to authenticate a digital signature acquired by the surface authentication scanner within the bar code scanner.

### DETAILED DESCRIPTION

Surface authentication technology provides a low cost method to establish the authenticity of documents and other items. Surface authentication may be used for identification and authentication in retail, medical, security, and other applications. Surface authentication may be used with most materials including paper, cardboard, plastics, metals, ceramics, and textiles and is ideal for protecting documents, personal identity, packaging, and products against counterfeiting and fraud. A surface authentication system uses a laser and detectors to analyze surface features of an item so as to generate a representation of the surface of the item, often in the form of a unique digital serial code that may be referred to as a “surface authentication digital serial code.” The surface authentication system may then encode the representation of the item as a unique digital serial code which may be transmitted, either via a wired connection or a wireless connection, and stored securely in a remote database.

Presently, there are no handheld scanners that can scan the surface of items to generate these digital serial codes. A surface authentication sensor could be integrated into a hand held scanner together with a bar code scanner to potentially create a low cost convenient user platform for authenticating items. An integrated surface authentication and bar code scanner may set specifications for the surface authentication and bar code regions on the surfaces of the items which are to be scanned. The specifications may include minimum and maximum sizes for the surface authentication regions and bar code regions and minimum and maximum separation distances between the surface authentication regions and the bar code regions.

The applications for image scanning by a bar code scanner having an integrated surface authentication system include counterfeit detection which may have large economic and safety implications because of products that fail and materials (such as medications) which are wrongly or fraudulently packaged. In some cases, these counterfeit products may even create life threatening situations. Surface authentication technology may address these issues by generating a representation of the surface of the item, which can be used to form secure digital signatures. In addition to the standard product identification bar code usually printed on medicine packages, a digitally encoded representation of this secure digital signature may also be printed on the packaging of an item. Alternatively, the digital signature may be stored in a central repository associated with the manufacturer of the item. For example, the central repository may be accessible through a bar code printed on the item packaging. Using this digital signature in conjunction with a bar code scanning device having an integrated surface authentication system, a user may scan the surface of the item using this bar code scanner to generate a local copy of the digital signature, where the bar code scanner may then provide this local copy of the digital signature to an authentication server to compare this local copy of the digital with the originally stored digital signature so as to authenticate the item as being manufactured by the stated manufacturer. In some instances, the bar code scanner itself may perform this comparison locally.

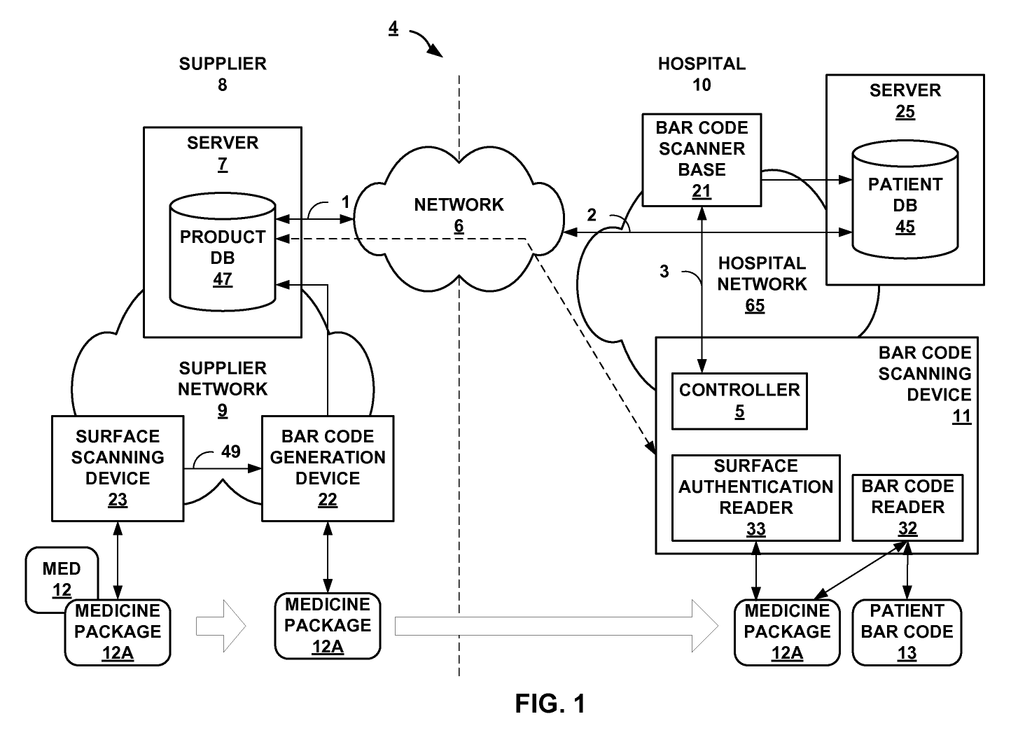

The following FIG. 1 sets out an example of a medical context in which the following techniques may be performed. While described in this context, the techniques may be generally implemented in any context, such as package delivery, document storage, and any other context that may benefit from ensuring the authenticity of an item.

FIG. 1 is a diagram illustrating a system 4 that performs various aspects of the integrated surface authentication techniques described in this disclosure. As shown in the example of FIG. 1, system 4 includes a network 6, supplier 8, and hospital 10. Network 6 may represent a public network, such as the Internet, that implements layer three (L3) network protocols, such as an Internet protocol (IP), to route or otherwise switch data in the form of packets from a source device to a destination device. In some instances, network 6 may comprise a private network that is owned and operated by one of supplier 8 or hospital 10 to facilitate communication between supplier 8 and hospital 10. Also, network 6 may represent a combination of both a public network and a private network when, for example, supplier 8 provides an interface to the public network with which hospital 10 may communicate via a public network to access supplier 8.

Supplier 8 may represent a supplier or manufacturer of an item. In the example of FIG. 1, supplier 8 is assumed to manufacture medicine 12 (“med 12”) and associated medicine package 12A. Supplier 8 may include a supplier network 9, which may represent a private network owned and operated by supplier 8 for purposes of facilitating communication between various devices operated by supplier 8 to manufacture medicine 12. Supplier network 9 may include a server 7 and a bar code generation device 22. Server 7 may represent a network device capable of hosting data, where this data typically relates to the items manufactured by supplier 8, i.e., data related to medicine 12 in the example of FIG. 1. Server 7 may host this data in the form of a product database 47 so that this data can be provided to customers of supplier 8, such as hospital 10. Bar code generation device 22 may represent a device that generates bar codes to be affixed to items, such as medicine package 12A. Bar code generation device 22 may generate the bar code for medicine 12, as one example, and affix this bar code to medicine package 12A for purposes of facilitating, in some examples, tracking, locating and identification of medicine 12.

Hospital 10 may generally represent a customer of supplier 8 that purchases or otherwise receives deliveries of items manufactured by supplier 8. Hospital 10 may include hospital network 65, which may represent a private network owned and operated by hospital 10. Hospital network 65 may facilitate communication between various devices included within hospital 10, such as bar code scanning device 11, bar code scanner base 21 and server 25. Bar code scanning device 11 represents a device capable of reading or, in other words, scanning bar codes affixed to items, such as medicine package 12A. Bar code scanner base 21 represents a so-called “base” in which bar code scanning device 11 may be inserted and/or coupled for purposes of charging, for example, or interfacing with a network, such as hospital network 65 and/or network 6.

While described in this disclosure with respect to base 21, the techniques may be performed by scanning devices that do not require or otherwise interoperate with a base. These scanning devices may be referred to as “stand-alone” scanning devices in that they do not require a base and therefore stand alone or separate from a base. Often, these stand-alone scanning devices may include a charging base or other connection that simply provides a cradle for charging the stand-alone scanning device, but that does not provide the various features described herein with respect to base 21. Accordingly, the techniques described in this disclosure may apply to both types of scanning devices including those that require a full-feature base 21 and those stand-alone scanning devices (which may optionally include a simple charging base).

Server 25 may be similar to server 7 in that server 25 may represent a network device that hosts data. In the context of hospital 8, server 25 may host data related to patients, where this patient data may be stored to a patient database shown as “patient DB 45” in the example of FIG. 1. While both of server 25 and server 7 are shown as residing on-site or locally within hospital 10 and supplier 8 in the example of FIG. 1, one or more of server 25 and server 7 may be remotely located from hospital 10 and supplier 8. That is, server 25 and server 7 may be located in a public network and a secure connection may be provided by which hospital 10 and supplier 8 may access servers 25 and 7. Accordingly, the techniques should not be limited in this respect to the example of FIG. 1.

In operation, supplier 8 manufactures, or in some instances, receives medicine 12 from a manufacturing facility. Supplier 8, when not manufacturing medicine 12, may receive medicine 12 for purposes of distributing medicine 12 to customers of the manufacturer, such as hospital 10. In any event, supplier 8 may utilize bar code generation device 22 to generate a bar code that can be affixed to medicine package 12A. In some instances, bar code generation device 22 may print the bar code directly on medicine package 12A of medicine 12. In other instances, bar code generation device 22 may print a label that includes the bar code, which bar code generation device 22 or an employee of supplier 8 affixes to medicine package 12A. In the example of FIG. 1, it is assumed that the bar code is affixed to medicine package 12A for ease of discussion purposes. Supplier 8 then transports medicine 12 enclosed in medicine package 12A to the purchaser of medicine 12, which is assumed to be hospital 10 in the example of FIG. 1.

Hospital 10 receives this medicine 12 and processes medicine 12 so that medicine 12 is able to be subscribed by doctors of hospital 10 to patients of hospital 10. Typically, processing of this medicine involves utilizing bar code scanning device 11 (which may also be referred to as “bar code scanner 11”) to scan the bar code affixed to medicine package 12A, where bar code scanning device 11 may interface with server 25 to update a medicine database (not shown in the example of FIG. 1 for ease of illustration purposes). A pharmacist or other department of hospital 10 may maintain this medicine database so as to reflect the current stock of medicine that is available to be prescribed to patients of hospital 10.

In any event, once entered into this medicine database, a doctor may prescribe medicine 12 to one or more patients of hospital 10. Typically, each patient of hospital 10 is identified with a unique identifier that is often encoded as a bar code and affixed to the patient in the form of a bracelet. When prescribing medicine 12, the doctor may interface with patient database 45 hosted by server 25 to indicate that this medicine 12 has been prescribed for the patient, effectively associating the bar code affixed to medicine 12 with the bar code affixed to the patient. In the example of FIG. 1, the patient bar code is shown as “patient bar code 13.” That is, the doctor may update a patient record stored in patient database 45 associated with the patient to which patient bar code 13 has been affixed to reflect that medicine 12 has been prescribed to this patient. Once this order has been entered into the computer by the doctor, the doctor or, more likely, a nurse or other employee of hospital 10 may administer medicine 12 to the patient to which patient bar code 13 has been affixed.

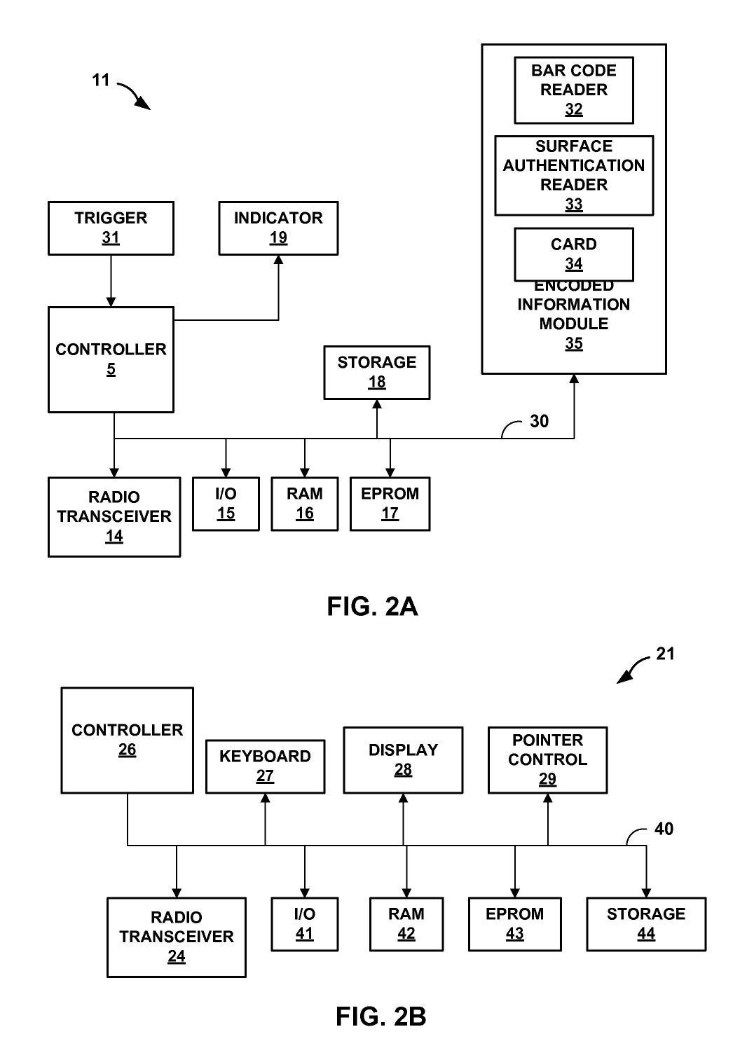

When administering medicine 12 to the patient having patient bar code 13, the nurse may interface with bar code scanning device 11 to first scan the product identification bar code affixed to medicine package 12A. The product identification bar code may uniquely define a particular configuration of medicine, such as a 36 count bottle of aspirin, but may not uniquely define the particular bottle of aspirin. The nurse may then scan patient bar code 13 so as to verify that the patient to which medicine 12 is to be administered is the proper patient. In other words, the nurse may authenticate the patient to which patient bar code 13 has been affixed as the proper patient to which medicine 12 is to be administered. In the example of FIG. 1, bar code scanning device 11 includes a bar code reader 32 shown as part of encoded information module 35 in FIG. 2A. Bar code reader 32 represents a module or unit configured to read bar codes, such as the product identification bar code affixed to medicine 12 and patient bar code 13, so as to obtain bar code data. In this instance, bar code data from patient bar code 13 may uniquely identify the patient to which patient bar code 13 has been affixed. Bar code scanning device 11 further includes controller 5, which may be configured to authenticate patients as valid recipients of medicine 12.

To authenticate the patient as the proper recipient of medicine 12, bar code scanning device 11 may invoke controller 5, which may communicate with patient database 45 to locate the patient record associated with the bar code data determined from scanning patient bar code 13. In other words, controller 5 may access patient database 45 using the bar code data determined from scanning patient bar code 13 as a key to retrieve a patient record or a portion thereof (such as the portion of patient record describing prescribed medications) associated with the patient to which patient bar code 13 has been affixed. Controller 5 may then determine whether medicine 12 has been prescribed for the patient to which patient bar code 13 has been affixed by determining whether the bar code data determined by scanning the bar code affixed to medicine package 12A (which may also be referred to as “medicine product identification bar code data”) is specified in the patient record. If this medicine bar code data is not specified in the retrieved patient record, the nurse may not administer medicine 12 to the patient. However, if the patient record includes corresponding medicine product identification bar code data, the nurse may administer medicine 12 to the patient.

While bar code scanners may facilitate the capture or acquisition of data in a number of contexts, including the medical context noted above, bar code scanners may not eliminate certain security risks. For example, a medicinal package may contain counterfeit medicine from an unknown supplier. The unknown supplier may have substituted the counterfeit medication into a package from a legitimate supplier, or the unknown supplier may have also produced a counterfeit medicinal package which replicates the bar code on a legitimate medicinal package. The bar code from the legitimate medicinal package may be well known and may be relatively easy to reproduce. Thus, a valid bar code on a medicinal package may not guarantee that the medicine inside the package is authentic, which can compromise patient safety if the patient receives a counterfeit medicine which may be ineffective or even harmful to that patient

In accordance with the surface authentication techniques described in this disclosure, bar code scanning device 11 may provide surface authentication in combination with bar code scanning to facilitate authentication of an item as a valid item. Using these techniques, bar code scanning device 11 may verify the integrity of products or items associated with bar codes or other machine-readable indicia. Rather than rely solely on a bar code to authenticate an item, bar code scanning device 11 may augment bar code scanning with a surface authentication process. Surface authentication generally involves scanning a surface of an item to produce a digital serial code that, in general, provides a first representation of the surface of this item. This surface representation may be at a resolution that enables two similar items (e.g., identical medicine containers that contain different medicines or medicines at different doses) to be distinguished from one another.

Bar code scanning device 11 may perform the techniques described in this disclosure to both read a bar code to obtain product identification bar code data and perform this surface scan to determine a first representation of the surface (e.g., in the form of the above noted digital serial code). Bar code scanning device 11 may then authenticate the item based on both the bar code data and the representation of the surface, which again may be provided in the form of a surface authentication digital serial code. This representation of the surface of the item may generally also be referred to as “surface authentication data.” By authenticating the item based on the representation of the surface of the item, the techniques may promote efficient authentication of the item in a way that may reduce the risk of forgery or counterfeiting.

To enable bar code scanning device 11 to perform this authentication, supplier 8 may generate the bar code affixed to medicine package 12A in a manner that facilitates this surface authentication process. As shown in the example of FIG. 1, supplier 8 includes a surface scanning device 23 that scans medicine package 12A prior to generation of an authentication bar code that is to be affixed to medicine package 12A so as to determine a representation of the surface of medicine package 12A, where this representation may comprise a digital serial code. Surface scanning device 23 may pass this representation of the surface of medicine package 12A to bar code generation device 22, where this representation is shown as surface representation 49 in the example of FIG. 1.

Rather than simply generate a bar code based off of a number not currently used to identify any products or items as is common when only bar codes are used to uniquely identify an item, bar code generation device 22 may generate the bar code to be affixed to medicine package 12A based on surface representation 23. Bar code generation device 22 may then generate this bar code based on surface representation 49 and affix this authentication bar code to medicine package 12A. Bar code generation device 22 may create a record in product database 47 for medicine package 12A based on the authentication bar code generated for medicine package 12A. Bar code generation device 22, when creating this record for medicine package 12A, may also store surface representation 49 to the record for later use in authenticating medicine package 12A. As the manufacturing process creates more containers of medicine 12 with the same bar code, supplier server 7 builds the product database 47 with unique instances of surface representation 49 for each container which may all be associated with the same bar code.

Additionally or alternately each surface representation 49 might also be associated with a date code, lot code, or other similar identification information. Such information may be made available to users in a confidential manor with the application of a private key-public key security system. The manufacturer may encrypt the information with a private key and the user may access this database with a public security key. In this manner, the user may determine with some amount of confidence that the database being accessed is in fact created and maintained by a secure manufacturer. Alternately, the authentication data may be encrypted with a private key which would be supplied to the user, i.e., hospital 65 in the example of FIG. 1, prior to delivery of medicine 12.

At hospital 10, when administering medicine 12, the nurse may interface with bar code scanning device 11 to perform a surface scan of medicine package 12A with surface authentication reader 33 in addition to invoking bar code reader 32 to read the bar code affixed to medicine package 12A. As shown in the example of FIG. 1, bar code scanning device 11 further includes a surface authentication reader 33, which is configured to scan a surface of an item, such as medicine 12, to produce a representation of the item. The nurse may interface with bar code scanning device 11 to invoke surface authentication reader 33, which may then scan or otherwise read the surface of medicine package 12A to obtain a representation of the surface of the item such as a digital serial code.

Thus, before a hospital staff member (e.g., the nurse) administers a medicine 12 to a patient, the staff member may use bar code scanner 11 to read a bar code printed on medicine package 12A to obtain bar code authentication data and product identification data and may use surface authentication reader 33 to perform a surface scan on the medicine to obtain a representation of the surface of medicine package 12A. Bar code scanner device 11 may then invoke controller 5 so that the decoded bar code data and surface authentication data (which again may refer to the first representation of the surface of the item) are sent through bar code scanner base 21 to hospital server 25. The data are then used to access an authorization code from patient database 45 which is returned to bar code scanner 11 via bar code scanner base 21. Patient database 45 may be established based on information from product database 47 in supplier network 9 which server 25 may access via link 2 to network 6 and then via link 1 to supplier server 7. Supplier network 9 may reside at a manufacturing site where medicine 12 is packaged, a distribution center where the medicine is assembled in bulk packaging, or a different supplier location.

Server 25 compares this bar code and surface authentication data with information in patient database 45. Server 25 will match the bar code from bar code scanner 11 with an identical bar code from patient database 45 related to the medicine 12 that the nurse wishes to administer to the patient. Server 25 may use the decrypted surface authentication digital serial code obtained from the surface authentication digital serial code derived by scanning medicine package 12A to verify the authenticity of the surface authentication data obtained from the authentication reader 33. This decryption may be performed, as noted above, using a private key previously supplied by the manufacturer to hospital 10. If server 25 determines that medicine package 12A is authentic, hospital server 25 may send an affirmative authorization code to bar code scanning device 11 via, in some instances, bar code scanner base 21. Bar code scanning device 11 may then indicate to the nurse that an affirmative authorization code allows the nurse to administer medicine 12 to the patient.

Alternately, server 25 may check the surface authentication digital serial code from bar code scanning device 11 against a list of known surface authentication digital serial codes related to the product identification codes against a list of known surface authentication digital serial codes. Hospital server 25 may update the list of known surface authentication digital serial codes periodically, such as daily, with information server 7 sends to hospital server 25 through authentication network 6. If server 25 finds the surface authentication digital serial code from bar code scanner 11 in a list of known serial codes related to the bar code received from the bar code scanner, server 25 may send an affirmative authorization code to the bar code scanner.

In some examples, server 25 may compare a first representation of the surface of the item captured by surface authentication reader 33 to a second representation of the surface of the item provided by the manufacture and stored to product database 47. Server 25 may retrieve the second representation of the surface of the item from a manufacturer or other database using the bar code data as a key. This bar code data may, again, comprise one or more of a date code of manufacture or shipping of medicine 12, a lot number of medicine 12, bar code content and, in some examples, the second representation of the surface. This comparison may be statistical in nature, where a certain level or threshold correlation may indicate that the item is authentic. That is, the first representation of the surface and the second representation of the surface may not be exactly the same due to differences in scanning the item (e.g., changes in the areas of the surface scanned between scanning the item to capture the first and second representations). In some examples, the first representation captured by scanning module may be a derivative of the second representation captured during manufacture of the item. In this way, server 25 may authenticate the item by performing a statistical comparison of the first representation of the surface of the item to the second representation of the surface of the item. In some examples, bar code scanning device 11 rather than server 25 may perform this authentication by comparing the first representation of the surface to the second representation of the surface.

In any event, bar code scanning device 11 may then indicate to the nurse that an affirmative authorization code allows the nurse to administer medicine 12 to the patient. If server 25 determines that the surface authentication digital serial code from bar code scanning device 11 is not in a list of known serial codes related to the bar code received from the bar code scanner, server 25 may send a negative authorization code to the bar code scanning device 11. Bar code scanner 11 may then indicate to the nurse that a negative authorization code disapproves of the nurse administering medicine 12 to the patient. In this case, hospital server 25 may assemble the bar code data and related surface authentication serial codes from an offending medicine package 12A of medicine 12 into a portion of patient database 47 reserved for counterfeit packages to allow further analysis.

While described above in the context of administering medicine 12 at hospital 10, the techniques of this disclosure may be employed in a wide variety of settings with regard to any type of item. Accordingly, the techniques described in this disclosure should not be limited to the medical context described in the example of FIG. 1. For example, bar code scanner 11 may be used in a package shipping application where package shipping personnel or automated machinery may scan packages prior to delivery to or after pickup from shipping customers. In this application, a delivery truck may be used to transport packages to and from a customer site. While at or near the customer site, delivery personnel may utilize bar code scanner 11 to authenticate packages transported to and from the customer. Within the delivery truck, there may be a server 25 to which bar code scanner 11 may communicate, via bar code scanner base 21 or alternately directly to either of the network 6 or network 2. e.g. via a wireless personal area network (WPAN) interface, in order to authenticate packages. Server 25 may communicate remotely with network 6 via link 2 which may be provided by a cell phone. Network 6 may in turn communicate via link 1 with server 7 at supplier 8. In this way, bar code scanner 11 may communicate remotely with server 7 at supplier 8 to authenticate packages at the customer site. This authentication process may also occur at a distribution center for a package shipping company.

In some cases of the package shipping application, bar code scanner 11 may be preloaded with authentication data remotely from server 7 at supplier 8 via the communication links previously mentioned. The authentication data may include bar codes and surface authentication digital serial codes related to packages that delivery personnel are transporting to and from the customer site. Utilizing the preloaded authentication data, bar code scanner 11 may scan packages at the customer site in order to confirm their authenticity upon pickup or delivery. Bar code scanner 11 may be used to confirm the authenticity of packages at the customer site upon customer request, in matters of high security, for items of high value, or for another reason. Package authentication at the customer site may be offered as a service to the customer for an additional charge which may create an additional revenue stream for the package shipping company.

Moreover, while described above with respect to medicine package 12A, in some instances, the techniques may be implemented with respect to medicine 12 itself, such as solid medicines, where a surface authentication scan may be possible (in contrast to liquid medicines). In these instances, the doctor or nurse may scan a particular portion of the medicine, where the portion may be marked or otherwise identified on a pill or other type of medicine. Thus, while described above with respect to authenticating the surface of medicine package 12A, the techniques may be performed with respect to medicine 12 itself and should not be limited to the example described above.

FIGS. 2A and 2B are block diagrams illustrating respective bar code scanner 11 and bar code scanner base 21 in more detail. Bar code scanner 11 and bar code scanner base 21 may each respectively include a radio transceiver 14 and 24 which may be utilized to communicate wirelessly from the bar code scanner to the bar code scanner base. In one embodiment, radio transceivers 14, 24 may each include a Bluetooth radio transceiver. Both bar code scanner 11 and bar code scanner base 21 may incorporate the Bluetooth protocol stack. Radio transceivers 14, 24 enable bar code scanner 11 to wirelessly transmit authentication data (e.g. bar codes and surface authentication digital serial codes) to bar code scanner base 21, and then to server 25, network 6, and server 7 via links 3, 2, 1 respectively of FIG. 1. In this way, bar code scanner 11 may communicate remotely to transmit authentication data to and receive confirmation data from server 7 at supplier 8. In addition or instead, bar code scanner 11 may remotely communicate such data directly with server 25. Bar code scanner 11 may also receive authentication data remotely from server 7 and server 25 and compare the authentication data at the scanner to determine the authenticity of a scanned item.

Additional components may be incorporated into bar code scanner 11. As part of encoded information module 35 interfaced to scanner system bus 30, bar code scanner 11 may include one or more of bar code reader 32, surface authentication reader 33, and card reader 34. In another example (not shown), one or more of bar code reader 32, surface authentication reader 33, and card reader may be directly interfaced with controller 5. Bar code reader 32 may include an image sensor assembly including an image sensor array and a lens for focusing an image of a substrate bearing a bar code onto the image sensor array. The image sensor array may be provided by a number of device technologies such as complementary metal oxide semiconductor (CMOS), charge coupled device (CCD), or charge injection device (CID). The image sensor array may include a plurality of pixels formed in a plurality of rows and columns of pixels. In one embodiment, the image sensor may have a pixel array of 1280×1024 pixels. In another embodiment, the image sensor array could be a linear image sensor array having an array of 3648×1 or 1280×2 pixels. The image sensor system included in bar code reader 32 may be operated by controller 5. In response to receipt of a trigger signal as may be initiated by depressing trigger 31, controller 5 may send frame capture commands via scanner system bus 30 to the image sensor system of bar code reader 32. When controller 5 has captured a frame of image data from bar code reader 32 into working memory in RAM 16, the controller may further process the image data for decoding of bar codes. Alternately, bar code reader 32 may be a laser scanner in some examples.

Controller 5 may generally represent hardware, such as a processor, application specific integrated circuit (ASIC), and field programmable gate array (FPGA). Controller 5 may execute instructions in the form of a program or computer program product that is stored to a non-transitory computer-readable medium, such as RAM 16, storage 18 and/or EPROM 17. Controller 5 may therefore represent any type of hardware that may be configured to perform the item authentication techniques described in this disclosure.

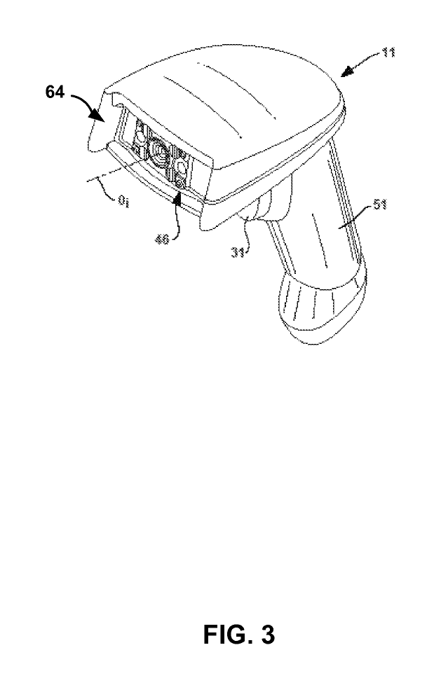

Bar code scanner 11 may also include a program memory in EPROM 17, storage 18, such as a hard drive, and indicator 19. Bar code scanner 11 may also include input/output (I/O) interface 15 such as an Ethernet or USB interface. All of the above components described relative to bar code scanner 11 may be incorporated in a portable hand held housing 51 as shown in FIG. 3 which can be operated at a location spaced apart from bar code scanner base 21.

Bar code scanner base 21 may include additional components such as controller 26, keyboard 27, display 28, pointer controller 29, and radio transceiver 24 as described previously, I/O interface 41, a working memory in RAM 42, a program memory in EPROM 43, and storage memory 44 such as a hard drive. The components may be in communication with each other via scanner base system bus 40. While bar code scanner 11 may uniquely associate to bar code scanner base 21, it is understood that a bar code scanner may be uniquely associated to a computer. Bar code scanner 11 may be connected to bar code scanner base 21 by a wire, thereby potentially eliminating the need for transceivers 14 and 24.

Because encoded information module 35 of bar code scanner 11 can decode multiple forms of message data, it is understood in all instances described herein where it is described that bar code scanner 11 sends decoded message data to bar code scanner base 21, bar code scanner 11 could alternatively send decoded message data such as decoded surface authentication message data, decoded bar code message data, or decoded card message data. Bar code scanner 11 may be configured to decode encoded data in response to a user initiated command. Such a user initiated command may be initiated in response to trigger 31 being actuated, or in the case of card reader 34, a card being moved through a slot disposed on bar code scanner 11 (not shown). Where bar code scanner 11 incorporates a surface authentication (SA) reader 33, the scanner may be referred to as an SA reading terminal. Where bar code scanner 11 incorporates a bar code reader 32, the scanner may be referred to as a bar code reading terminal.

Alternately, each item may have a unique serial number that would be encoded as a bar code. User 10 may scan the item with bar code reader 32 and authentication reader 33. This information may then be transmitted to server 7 at the manufacturer. The manufacturer may compare this information with the information in the product data base 47. If the information matches, server 7 may generate and send the affirmative authentication message to controller 5. Alternately if the information does not match, server 7 may generate and send the negative affirmation authentication message to the user. In some examples, these messages may be encrypted through the use of private keys or, in some examples, with an appropriate combination of private and public keys, depending upon the type and degree of security desired.

Surface authentication technology may offer a way of uniquely identifying an item by a representation of the surface of the item created at the time the item is manufactured. The representation of the surface of the item in the form of a digital serial code may be printed on the packaging of the item such as in the bar code of the item. Alternatively, the digital serial code may be stored in a database associated with the manufacturer of the item. For example, the database may be accessible through a bar code printed on the item packaging. This part of the process could be further enhanced by: (a) restricting database access through user identification numbers to only recognized users, (b) removing or tagging digital serial codes in the database as they are used to prevent the reuse of the same digital serial code, and (c) the item's history could be noted in the database so that one could track the item through a distribution channel. In one application, a scanned document may have a bar code that provides the surface authentication digital serial code of a box to which the document is stored.

FIG. 3 is a drawing showing an example of bar code scanner 11 of FIG. 1. As shown in FIG. 3, bar code scanner 11 includes an imaging module 46, housing 51, and manual trigger 31. Bar code scanner 11 may internally incorporate radio transceiver 14, bar code reader 32, and SA reader 33 shown in FIG. 2A. Housing 51 may be configured so that trigger 31 can be actuated when housing 51 is grasped by the user. In one embodiment, a bar code reader terminal may contain hand held housing 51 without a display and include at least one component of bar code reader 32 and SA reader 33. Housing 51 is configured in this example so that a user can actuate manual trigger 31 when grasping the housing. The bar code reading terminal can be configured so that when the manual trigger is actuated, the bar code reader terminal produces a decoded bar code data message and a decoded surface authentication data message.

Housing 51 includes cowling 64 which may protrude beyond the front of imaging module 46 on the side faces, top face, and bottom face of the opening in the housing which surrounds the front of the imaging module. The user may press bar code scanner 11 against the surface of the item being scanned so as to prevent any stray light from affecting the surface authentication scan. An optional gasket such as a foam gasket (not shown) may be attached to cowling 64 in order to cushion bar code scanner 11 and keep out any stray light when the user presses the scanner against the surface of the item being scanned. The exact shape of cowling 64 may influence the angle at which an item is scanned by bar code scanner 11 so that, when the four sides of the cowling are pressed flat against the item being scanned, the bar code scanner maintains a desired angle relative to the surface of the item being scanned.

Imaging module 46 may contain both bar code reader 32 and surface authentication reader 33 which may each acquire an image through the same imaging window or through separate imaging windows. If bar code reader 32 and surface authentication reader 33 use the same imaging window or separate imaging windows, the outside dimensions of the same imaging window or of the combined separate imaging windows may be no larger than some maximum size, e.g. two inches high by six inches wide, within cowling 64 of bar code scanner 11. The image acquisition optics of bar code reader 32 and surface authentication reader 33 may be oriented side-to-side or top-to-bottom within bar code scanner 11. In either side-to-side or top-to-bottom orientation, the image acquisition optics of bar code scanner 11 may be separated side-to-side or top-to-bottom by no more than some maximum length, e.g. by two inches. Alternately bar code reader 32 and surface authentication reader 33 may be in separate housings, each potentially optimized for the functionality of the specific reader functionality.

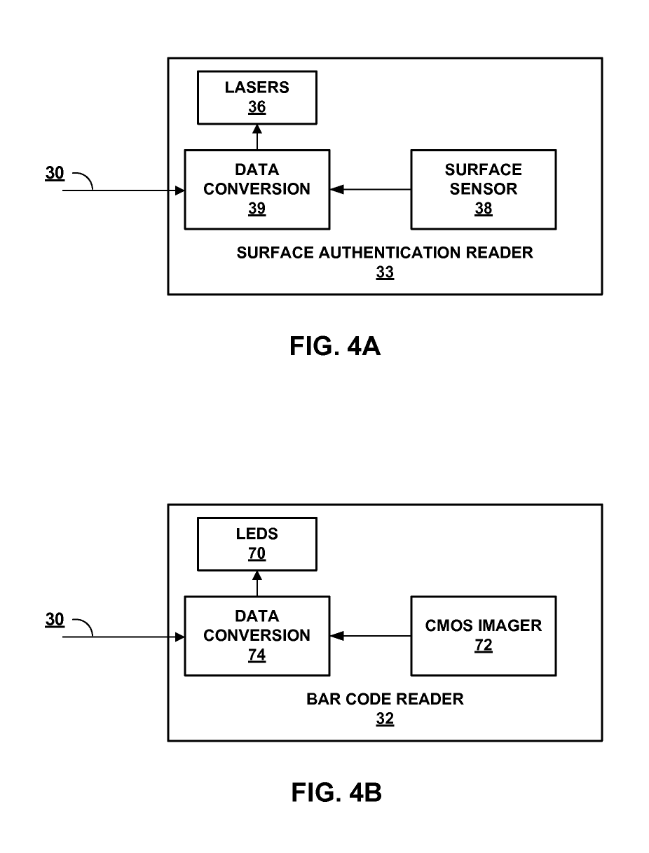

FIG. 4A is a block diagram illustrating components of SA reader 33 that can be incorporated as part of bar code scanner 11 shown in the example of FIG. 3. SA reader 33 may include lasers 36, a surface sensor 38, and data conversion circuit 39. SA reader 33 may be used to perform a surface scan of an item on a specified surface scan region of the item to obtain a representation of the surface of the item. The image acquisition elements such surface senor 38, in SA reader 33 may be operated by controller 5 through data conversion circuit 39. In response to receipt of a trigger signal as may be initiated by depressing trigger 31 (shown in the example of FIG. 3), controller 5 may send frame capture commands via scanner system bus 30 (shown in the example of FIG. 2A) to data conversion circuit 39 of SA reader 33. Data conversion circuit 39 may supply surface sensor 38 with the appropriate timing and drive circuits to generate image data. Surface sensor 38 may comprise, to provide one example, one or more cameras.

When controller 5 has captured a frame of image data from data conversion circuit 39 of SA reader 33 into RAM 16, controller 5 may further process the SA image data for decoding of SA digital serial codes, e.g. as obtained from medicine package 12A of FIG. 1. Data conversion circuit 39 of SA reader 33 may include a low cost microcontroller to process the received image signal information from surface sensor 38 in order to decode the surface authentication data generated by the surface features of the item being scanned. Surface authentication data may be acquired from, for example, articles for sale in a retail store, medicinal packages, secure documents, or from an identification card such as a credit or debit card.

FIG. 4B is a block diagram illustrating components of bar code reader 32 that can be incorporated as part of bar code scanner 11. Bar code reader 32 may include light emitting diodes (LEDs) 70 (“LEDS 70”), a CMOS imager 72, and data conversion circuit 74. Bar code reader 32 may be used read bar codes on a package, such as package 12A. LEDs 70 and CMOS imager 72 may represent one example of an image acquisition module or unit that is capable of capturing an image. Controller 5 may operate both LEDs 70 and CMOS senor 38A through data conversion circuit 74 via scanner system bus 30. In response to receipt of a trigger signal as may be initiated by depressing trigger 31, controller 5 may send frame capture commands via scanner system bus 30 to data conversion circuit 74 of bar code reader 32. Data conversion circuit 74 may operate light emitting diodes 70 with the appropriate timing and drive circuits to generate image data.

When controller 5 has captured a frame of image data from data conversion circuit 74 of bar code reader 32 into RAM 16, controller 5 may further process the bar code image data for decoding of bar codes, e.g. as obtained from medicine package 12A of FIG. 1. Data conversion circuit 74 of bar code reader 32 may, similar to data conversion unit 39, include a low cost microcontroller to process the received image signal information from CMOS imager 72 in order to decode the bar code symbol being scanned. While described with respect to a CMOS imager 72, the techniques may apply to other type of imaging units, including a laser scanner.

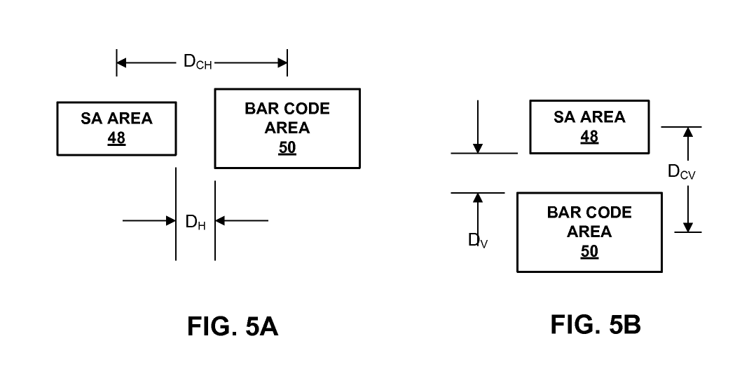

FIG. 5A and FIG. 5B are drawings illustrating the distances of separation between surface authentication scan area 48 and bar code scan area 50 in a horizontal and vertical orientation on the surface of the item being scanned. In FIG. 5A, surface authentication scan area 48 and bar code scan area 50 are placed in a horizontal configuration with separation distance D_{H} between the outer boundaries of the two scan areas and a separation distance D_{CH} between the centers of the two scan areas. In FIG. 5B, surface authentication scan area 48 and bar code scan area 50 are placed in a vertical configuration with separation distance D_{V} between the outer boundaries of the two scan areas and a separation distance D_{CV} between the centers of the two scan areas. Design specifications of bar code scanner 11 may set limitations on these separation distances. In the example of FIG. 1, as bar code scanner 11 inspects individual containers of medicine 12, bar code reader 32 and surface authentication reader 33 may concurrently or successively scan the bar code area 50 and surface authentication area 48, respectively, as shown in FIG. 5A and FIG. 5B.

In this respect, the techniques may provide for an article, such as medicine 12, that includes a surface authentication scan area that represents a marked portion of the article denoting a portion of a surface of the article that is to be surface scanned to generate a surface authentication digital serial code that uniquely identifies the article. The techniques may also provide for a bar code scan area 50 to which a bar code is affixed or printed. This bar code, as noted above, may encode bar code data that specifies the surface authentication digital serial code for use in authenticating the article in the manner described above. Moreover, in accordance with the techniques described in this disclosure, the marked portion and the bar code may be located within a set distance from one another so as to enable a bar code scanning device to surface scan both the marked portion and the bar code without having to reposition the bar code scanning device. The bar code may also contain dimensional information defining the location of the authentication area relative to the bar code location or alternately any other uniquely defined feature of the article.

In order to fit bar code scanner 11 into a compact sized housing, design specifications of the bar code scanner may set maximum allowable values for D_{H}, D_{V}, D_{CH}, and D_{CV}. Setting maximum allowable values for the separation distances may also restrict the possibility of placing two item packages adjacent to one another in order to scan surface authentication area 48 on one item package and bar code area 50 on the other item package. Both surface authentication scan area 48 and bar code scan area 50 may vary in size and aspect ratio according to the particular item being scanned which may indicate that separation distances D_{CH} and D_{CV} may be more frequently used than D_{H} and D_{V} in design specifications for bar code scanner 11.

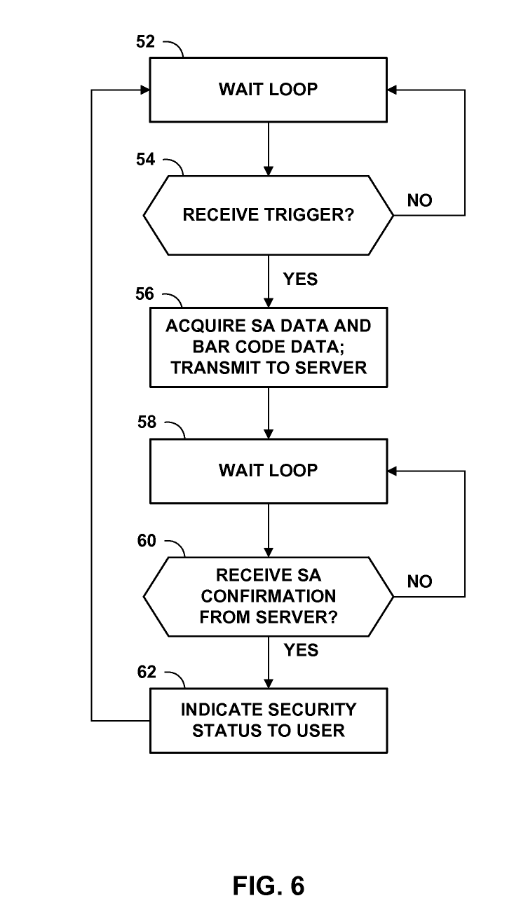

FIG. 6 is a flowchart illustrating steps of a process that can be carried out by bar code scanner 11 operating within hospital network 65 to authenticate a surface authentication digital serial code acquired by SA reader 33 within the bar code scanner. Controller 5 of bar code scanner 11 may begin an algorithm for the example method by executing an initial wait loop (52) for the user to actuate manual trigger 31. Controller 5 must receive a trigger signal from actuator 31 (54) in order to process an SA scan and a bar code scan and transmit the decoded SA data and the decoded bar code data to server 25 (56), otherwise the controller returns to the initial wait loop (52). After controller 5 of bar code scanner 11 transmits the representation of the surface and bar code data to server 25 (56), the controller executes another wait loop (58) until the bar code scanner receives an SA confirmation message from server 25 (60), at which time the controller may indicate to the user on indicator 19 or by another method the security status received from the server (62) related to the SA data and bar code data which was transmitted to the server (56). Once the security status has been indicated to the user, controller 5 may proceed back to the initial wait loop (52).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” or “controller” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware. Alternately the processing might be implemented in a distributed computing environment, such as might be implanted with cloud computing.

Various embodiments of the invention have been described. These and other embodiments are within the scope of the following claims.

1. A method comprising:
reading, with a bar code reader of a scanning device, a bar code affixed to an item to determine bar code data;
reading, with a surface reader of a scanning device, a surface of the item to determine a representation of the surface; and
determining, with the scanning device, whether the item is authentic based on the bar code data and the representation of the surface.

2. The method of claim 1,
wherein the representation of the surface comprises a first representation of the surface,
wherein determining whether the item is authentic comprises:
transmitting the bar code data and the first representation of the surface to a server so that the server is able to retrieve a second representation of the surface using the bar code data and compare the first representation of the surface to the second representation of the surface in order to determine whether the item is authentic; and
receiving authentication data from the server indicating whether the item is authentic based on the comparison of the first representation of the surface to the second representation of the surface.

3. The method of claim 1,
wherein the representation of the surface of the item is encoded in the form of the bar code affixed to the item, and
wherein determining whether the item is authentic comprises comparing the representation of the surface to determine whether the representation of the surface matches at least a portion of the bar code data.

4. The method of claim 1,
wherein the representation of the surface of the items comprises a first representation of the surface of the item,
wherein determining whether the item is authentic further comprises:
accessing a database that stores a second representation of the surface of the item using the bar code data to retrieve the second representation of the surface of the item; and
authenticating the item by comparing the first representation of the surface of the item to the second representation of the surface of the item.

5. The method of claim 4, further comprising providing user authentication information to the database so as to gain access to the database to retrieve the second representation of the surface of the item from the database.

6. The method of claim 1, wherein the bar code affixed to the item is one of a one-dimensional bar code and a two-dimensional bar code.

7. The method of claim 1, further comprising providing an indication that the item has been authenticated based on the determination of whether the item is authentic.

8. The method of claim 7, wherein providing the indication comprises providing the indication, with the scanning device, that the item has been authenticated based on the determination of whether the item is authentic.

9. A scanning device comprising:
a bar code reader configured to read a bar code affixed to an item to determine bar code data;
a surface reader configured to read a surface of the item to determine a representation of the surface; and
a controller configured to determine whether the item is authentic based on the bar code data and the representation of the surface.

10. The scanning device of claim 9,
wherein the representation of the surface comprises a first representation of the surface, and
wherein the controller is further configured to, when determining whether the item is authentic, interfaces with a transceiver to transmit the bar code data and the representation of the surface to a server so that the server is able to retrieve a second representation of the surface based on the bar code data and compare the second representation of the surface to the first representation of the surface, and
wherein the controller is further configured to, when determining whether the item is authentic, receive authentication data from the server indicating whether the item is authentic based on the comparison of the second representation of the surface to the first representation of the surface.

11. The scanning device of claim 10, wherein the controller, prior to transmitting the bar code data and the representation of the surface to the server, encrypts one or more of the bar code data and the representation of the surface to the server.

12. The scanning device of claim 9,
wherein the representation of the surface of the item is encoded in the form of the bar code affixed to the item, and
wherein the controller compares the representation of the surface to the bar code data to determine whether the representation of the surface matches at least a portion of the bar code data in order to validate the authenticity of the item.

13. The scanning device of claim 9,
wherein the representation of the surface comprises a first representation of the surface, and
wherein the controller is further configured to, when determining whether the item is authentic, accesses a database that stores a second representation of the surface of the item using the bar code data to retrieve the second representation of the surface of the item and authenticates the item by comparing the first representation of the surface of the item to the second representation of the surface of the item.

14. The scanning device of claim 13, wherein the controller further provides user authentication information to the database so as to gain access to the database to retrieve the second representation of the surface of the item from the database.

15. The scanning device of claim 9, wherein the bar code affixed to the item is one of a one-dimensional bar code and a two-dimensional bar code.

16. The scanning device of claim 10, wherein the controller is further configured to provide an indication that the item has been authenticated based on the determination of whether the item is authentic.

17. A non-transitory computer-readable medium comprising instructions that, when executed, cause one or more processors of a scanning device to:
interface with a bar code reader to read a bar code affixed to an item to determine bar code data;
interface with a surface scanner to read a surface of the item to determine a representation of the surface;
determine whether the item is authentic based on the bar code data and the representation of the surface; and
provide an indication that the item has been authenticated based on the determination of whether the item is authentic.

18. A system comprising:
a server; and
a scanning device, wherein the scanning device comprises:
a bar code reader configured to read a bar code affixed to an item to determine bar code data;
a surface reader configured to read a surface of the item to determine a representation of the surface; and
a controller configured to transmitting the bar code data and the representation of the surface to the server,
wherein the server authenticates the item based on the bar code data and the representation of the surface to determine authentication data identifying whether the item is authentic and transmits the authentication data to the scanning device, and
wherein the controller of the scanning device is further configured to receive the authentication data from the server indicating whether the item is authentic.

19. The system of claim 18, further comprising a computing device configured to provide an indication that the item has been authenticated based on the determination of whether the item is authentic

20. The system of claim 18, wherein the controller is further configured to provide an indication that the item has been authenticated based on the determination of whether the item is authentic

21. An article comprising:
a marked portion of the article denoting a portion of a surface of the article that is to be surface scanned to generate a surface authentication digital serial code that uniquely identifies the article; and
a bar code encoding bar code data that specifies the surface authentication digital serial code for use in authenticating the article.

22. The article of claim 21, wherein the marked portion and the bar code are located within a set distance from one another so as to enable a bar code scanning device to surface scan the marked portion and read the bar code without having to reposition the bar code scanning device.

23. The article of claim 21, wherein the marked portion and the bar code are located within a set distance form one another so as to enable a bar code scanning device to concurrently surface scan the marked portion and read the bar code.

24. The article of claim 21, wherein the bar code data includes data specifying one or more of a data code and a lot code.
